(19) United States
(12) Patent Application Publication
(10) Pub. No.: US 2007/0020024 A1
(43) Pub. Date: Jan. 25, 2007

(54) Lipstick-like pen

(76) Inventor: Ming-Yao Tsai, Tainan City (TW)

Correspondence Address: Thomas E. Sisson;Jackson Walker, LLP, Suite 2100, 112 E. Pecan, San Antonio, TX, 78205, US

(21) Appl. No.: 11/144,564

(22) Filed: Jun. 3, 2005

(51) Int. Cl. B43K 5/16; B43K 24/02

(52) U.S. Cl. 401/116; 401/99

(57) ABSTRACT

A lipstick-like pen includes a seat having a tubular part. A rotating sleeve is rotatably provided outside said tubular part. A moving sleeve is movably provided in said tubular part. A pen barrel is positioned in the moving sleeve and has a combined ink cartridge and stylus received in the pen barrel. The pen is shaped as a lipstick to provide an attractive and interesting appearance.

### BACKGROUND OF THE INVENTION

1. Field of the Invention

The present invention relates to a writing instrument, and more particularly to a lipstick-like pen which can be easily used and stored.

2. Description of Related Art

Conventional writing instruments including pencils, ball pens, etc. generally have a shank and a marking element such as a graphite rod, ink cartridge, and so on. The configurations and shapes of conventional pens are so common that they alone will not attract customers.

Therefore, the invention provides a novel pen to mitigate or obviate the aforementioned problems.

### SUMMARY OF THE INVENTION

The main objective of the present invention is to provide a lipstick-like pen which has an attractive appearance and can be conveniently stored and carried.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lipstick-like pen in accordance with the present invention;

FIG. 2 is a cross sectional view of the lipstick-like pen in FIG. 1;

FIG. 3 is a cross sectional view of the lipstick-like pen wherein a cap is removed for clarity;

FIG. 4 is a cross sectional view of the lipstick-like pen when a core extends out from a barrel;

FIG. 5 is an exploded perspective view of another embodiment in accordance with the present invention;

FIG. 6 is an exploded perspective view of a third embodiment in accordance with the present invention; and

FIG. 7 is an exploded perspective view of a fourth embodiment in accordance with the present invention.

### DETAILED DESCRIPTION OF THE PREFERRED EMBODIMENT

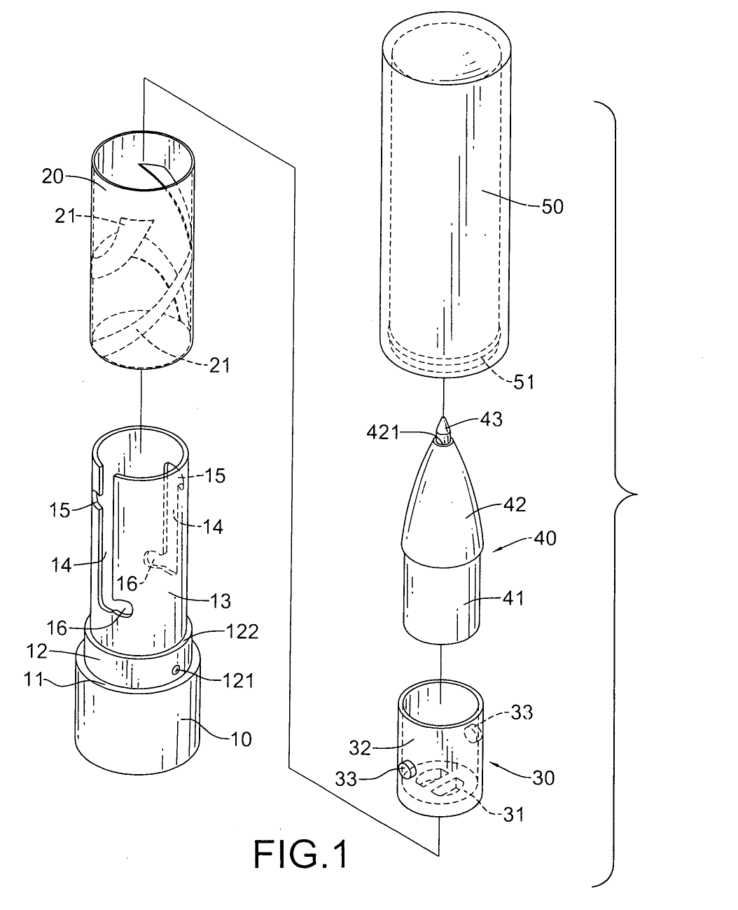

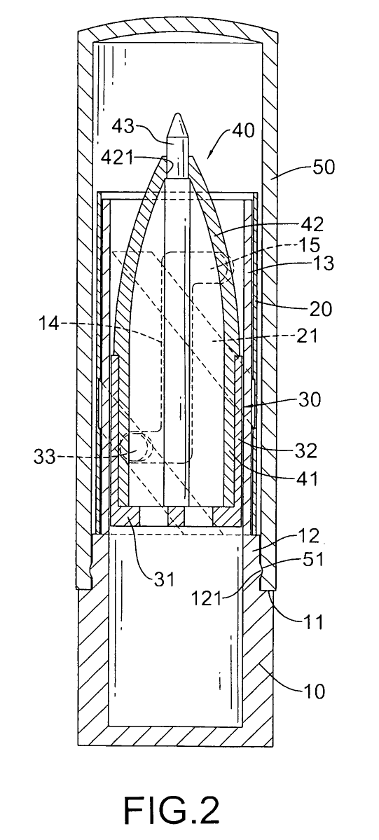

With reference to FIGS. 1-2, a pen in accordance with the present invention has a seat (10) with a tubular part (13). A rotating sleeve (20) is provided outside the tubular part (13). A moving sleeve (30) is received in the rotating sleeve (20). A pen barrel (40) is positioned in the moving sleeve (30) and a combined ink cartridge and stylus (43) is received in the pen barrel (40).

A flange (12) is formed between the seat (10) and the tubular part (13), wherein an outer diameter of the flange (12) is smaller than an outer diameter of the seat (10) but larger than that of the tubular part (13). A first step (121) is formed between the flange (12) and the seat (10), and a second step (122) is formed between the flange (12) and the tubular part (13). A lug (121) is formed at an outer periphery of the flange (12).

At least one slot (14) is longitudinally defined through the tubular part (13). An upper notch (15) is laterally defined at an upper portion of the slot (14), and a lower notch (16) is laterally defined at a lower portion of the slot (14).

The rotating sleeve (20) has at least one spiral slot (21) defined at an inner wall thereof. The slot(s) (14) has the same quantity as the spiral slot(s) (21).

The moving sleeve (30) has a bottom plate (31) formed at a lower end thereof and at least one nose (33) formed at an outer periphery (32) thereof. The moving sleeve (30) is received in the tubular part (13) to locate the nose (33) in the slot (14) and spiral slot (21).

The pen barrel (40) has a cylindrical part (41) and a cone-shaped part (42), wherein an outer diameter of the bottom of the cone-shaped part (42) is larger than an outer diameter of the cylindrical part (41). An opening (421) is defined at a tip of the cone-shaped part (42), and the combined ink cartridge and stylus (43) is received in the pen barrel (40) and extends out from the opening (421). The cylindrical part (41) is tightly received in the moving sleeve (30) and a rear end of the ink cartridge and stylus (43) abuts the bottom plate (31) to prevent the ink cartridge and stylus (43) from retracting during writing.

A cap (50) is provided outside the seat (10). An annular recess (51) is defined at an inner wall of the cap (50), and the lug (121) is positioned in the annular recess (51) to prevent the cap (50) from freely escaping.

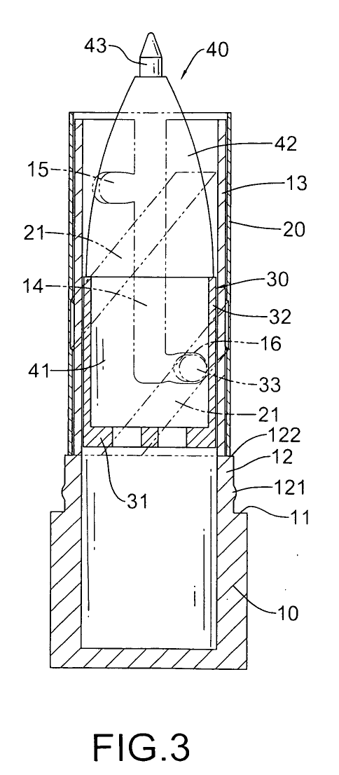

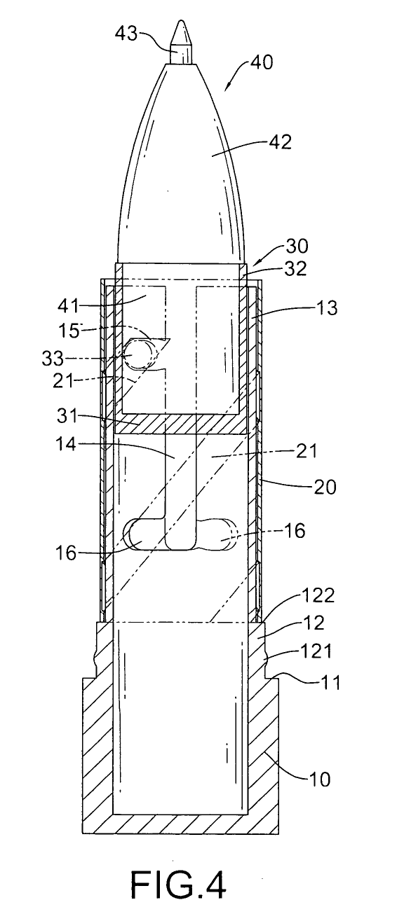

In use, as illustrated in FIGS. 2-4, the cap (50) is first removed. When the rotating sleeve (20) is turned about the seat (10), the nose (33) in the lower notch (16) is pushed by side walls defining the spiral slot (21) to enter into the slot (14) and move upwards along the slot (14) until the nose (33) enters into the upper notch (15). Thus, the pen barrel (40) along with the moving sleeve (30) is securely raised for writing.

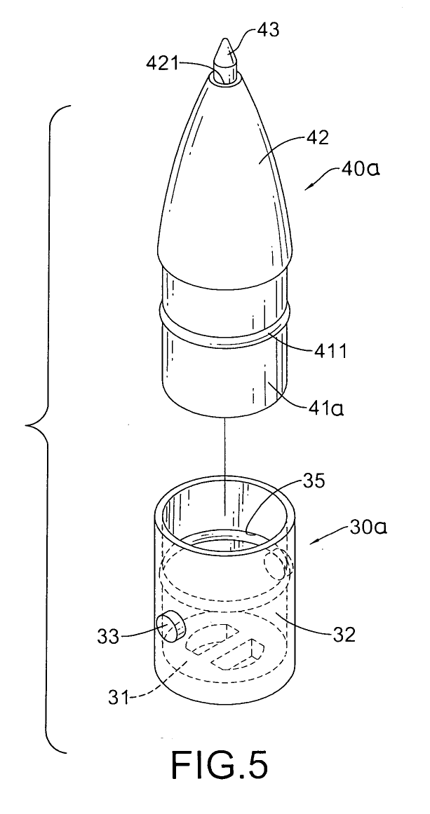

With reference to FIG. 5, in another embodiment, the moving sleeve (30a) has a ring recess (35) defined at an inner wall thereof, and the pen barrel (40a) has a rim (411) formed on the cylindrical part (41a) and positioned in the ring recess (35) so as to securely receive the pen barrel (40a) in the moving sleeve (30a).

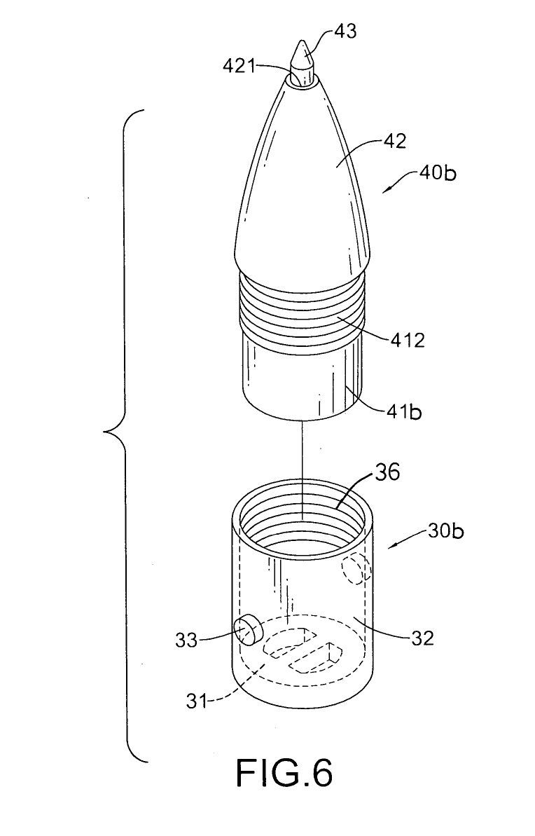

With reference to FIG. 6, in a third embodiment, the moving sleeve (30b) has an inner thread (36) formed at an inner wall thereof, and the pen barrel (40b) has an outer thread (412) formed at an outer periphery thereof. By engagement between the inner thread (36) and outer thread (412), the pen barrel (40b) is securely fastened in the moving sleeve (30b).

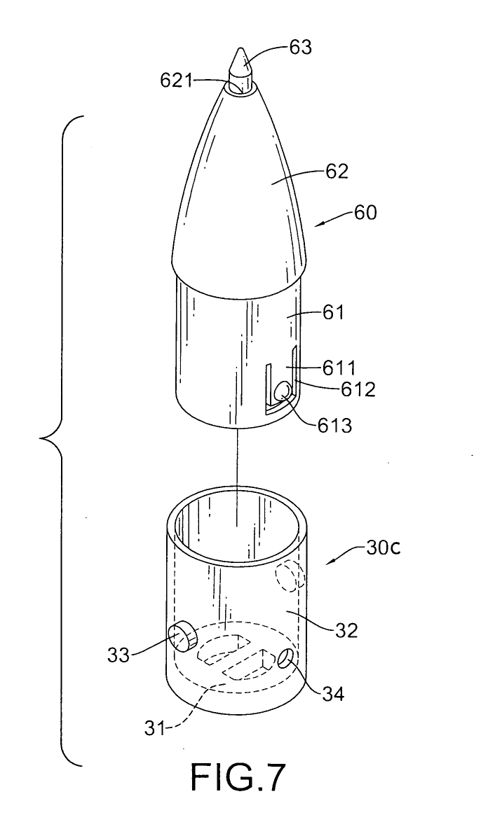

With reference to FIG. 7, in a fourth embodiment, the moving sleeve (30c) has an aperture (34) defined adjacent the bottom plate (31). The pen barrel (60) has a cylindrical part (61) and a cone-shaped part (62), wherein an outer diameter of the bottom of the cone-shaped part (62) is larger than an outer diameter of the cylindrical part (61). An opening (621) is defined at a tip of the cone-shaped part (62), and a combined ink cartridge and stylus (63) is received in the pen barrel (60) and extends out from the opening (621). An elastic tongue (611) is formed in a U-like channel (612), and a protrusion (613) is formed on the tongue (611). When the pen barrel (60) is inserted in the moving sleeve (30c), the protrusion (613) is positioned in the aperture (34) to fasten the pen barrel (60) in the moving sleeve (30c). For replacing the pen barrel (60), the protrusion (613) is pressed inwards and the pen barrel (60) can be removed from the moving sleeve (30c).

Therefore, the pen in accordance with the present invention is shaped as a lipstick to provide an attractive and interesting appearance. Moreover, the pen has a compact structure so as to be conveniently carried and stored.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lipstick-like pen comprising:
a seat (10) having a tubular part (13);
a rotating sleeve (20) rotatably provided outside said tubular part (13);
a moving sleeve (30) movably provided in said tubular part (13); and
a pen barrel (40) positioned in the moving sleeve (30) and having a combined ink cartridge and stylus (43) received in the pen barrel (40).

2. The lipstick-like pen as claimed in claim 1, wherein said seat (10) has at least one slot (14) longitudinally defined through said tubular part (13), said rotating sleeve (20) has at least one spiral slot (21) defined at an inner wall of the rotating sleeve (20), and said moving sleeve (30) has at least one nose (33) formed at an outer periphery (32) of said moving sleeve (30) and extending through said at least one slot (14) and positioned in said at least one spiral slot (21).

3. The lipstick-like pen as claimed in claim 2, wherein said seat (10) further has an upper notch (15) defined at an upper portion of said slot (14) and a lower notch (16) defined at a lower portion of said slot (16).

4. The lipstick-like pen as claimed in claim 1, wherein said pen barrel (40) has a cylindrical part (41), a cone-shaped part (42), an opening (421) defined through a tip of the cone-shaped part (42), and said combined ink cartridge and stylus (43) extends through said opening (421).

5. The lipstick-like pen as claimed in claim 4, wherein said moving sleeve (30a) has a ring recess (35) defined at an inner wall of said moving sleeve (30a), and said pen barrel (40a) has a rim (411) formed on the cylindrical part (41a) and positioned in the ring recess (35).

6. The lipstick-like pen as claimed in claim 4, wherein said moving sleeve (30b) has an inner thread (36) formed at an inner wall of said moving sleeve (30b), and said pen barrel (40b) has an outer thread (412) formed at said cylindrical part (41b) and engaged with said inner thread (36).

7. The lipstick-like pen as claimed in claim 4, wherein said moving sleeve (30c) has an aperture (34) defined through said moving sleeve (30c), and said pen barrel (60) has an elastic tongue (611) formed in a U-like channel (612) and a protrusion formed on the elastic tongue (611) and positioned in said aperture (340).

8. The lipstick-like pen as claimed in claim 1 further comprising a cap (50).

9. The lipstick-like pen as claimed in claim 8, wherein said cap (50) has an annular recess (51) defined at an inner wall of said cap (50), and said seat (10) has a flange (12) formed between said seat (10) and said tubular part (13), and a lug (121) formed on the flange (12) and positioned in said annular recess (51).
